(19) United States
(12) Patent Application Publication
(10) Pub. No.: US 2008/0069567 A1
(43) Pub. Date: Mar. 20, 2008

(54) System and method for regenerating infrared code signals

(75) Inventor: W. Eric Smith, Lindon, UT (US)

Correspondence Address: THORPE NORTH & WESTERN, LLP., 8180 SOUTH 700 EAST, SUITE 350, SANDY, UT, 84070, US

(73) Assignee: Control4 Corporation

(21) Appl. No.: 11/540,894

(22) Filed: Sep. 20, 2006

(51) Int. Cl. H04B 10/00

(52) U.S. Cl. 398/106

(57) ABSTRACT

A system and method is provided for regenerating infrared code signals configured to control an automated device. The method can include the operation of receiving a plurality of infrared control signals from an input source. A format of the infrared control signals from the input source can then be identified. A long hand representation of the infrared control signals can be regenerated based on an identified format of the infrared control signals. A further operation is storing the long hand representation of the infrared control signals in a control code database.

### FIELD OF THE INVENTION

The present invention relates generally to control of electronic devices.

### BACKGROUND OF THE INVENTION

In consumer electronic devices, such as televisions, cable boxes, satellite receivers, stereos, and the like, many functions and features of the devices may be accessed or controlled using a remote control type device. The remote control device may be user-activated, as in the case of a hand-held remote control. Alternatively, the remote control device may be device-activated, as in the case of a “relay” type of remote control.

A remote control may use a variety of wireless transmission mediums in order to send or transmit the generated control signal from a remote control or universal control to the receiving electronic device. One type of remote communication medium uses infrared (IR) light or radiation for transmission of the encoded control signals to an IR receiving sensor associated with the consumer electronic device. The consumer electronic device may include a microprocessor for decoding the received IR control code signals and performing the desired functions of the electronic device.

Remote controls or universal controls may transmit pulses or grouped bursts of IR energy to send a signal to the IR receiver in an electronic device. The IR LEDs transmit IR signals using a selected carrier frequency. Nearly any selected carrier frequency can be used but sometimes higher carrier frequencies in the kilohertz, megahertz, or higher ranges are used. The control code signals are transmitted by an IR LED and the signals may be interpreted as a binary code. For most consumer electronics, the various coding schemes have similarities but there are wide variations in the actual code transmission details. However, all the schemes have some combination of transitions between “on” bursts and “off” bursts at a carrier frequency to represent data bits.

An IR encoded control signal often consists of a data stream representing a given word length in which the presence of a group of infrared energy bursts at the carrier frequency may represent a binary 1 and the absence of infrared energy bursts may represent a binary 0. IR transmissions from a remote control are sometimes made up of a series of IR bursts and spaces of varying time lengths. Different combinations of the burst lengths, spaces, or edge transitions can be used to create IR codes.

When a button on a remote control is pushed, the remote may send a string of signals at the carrier frequency. One piece of information that may be in the string is called the preamble (or header). The preamble often contains a burst of transitions or pulses to alert all the IR receivers in the area that a string of data is being sent. Following the preamble, a command code may be sent containing the address to the specific machine intended to receive the next piece of data and the actual command or control code. As long as the remote control button is depressed, the control code may continue to repeat over and over or the command code may only repeat for a defined time period.

Each unique control code may represent a different key on the remote control or other information the remote control has been programmed to transmit. Consumer electronic devices have an extremely large variety of codes for the same features or similar features. As a result, a remote control or IR control device for one electronic device may not necessarily work with another electronic device.

### SUMMARY OF THE INVENTION

A system and method is provided for regenerating infrared code signals configured to control an automated device. One embodiment of a method can include the operation of receiving a plurality of infrared control signals from an input source. The format of the infrared control signals from the input source can then be identified. The long hand representation of the infrared control signals can be regenerated based on an identified format of the infrared control signals. A further operation can be storing the long hand representation of the infrared control signals in a control code database.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of a system for receiving and regenerating infrared control codes in an embodiment of the invention;

FIG. 2 depicts control codes in longhand format tables before and after regeneration has occurred in an embodiment of the invention;

FIG. 3 is a block diagram of a universal control, media controller, or home theater controller that can record and regenerate infrared control codes in accordance with an embodiment of the present invention;

FIG. 4 is a block diagram of a universal remote control that can learn and regenerate infrared control codes in accordance with an embodiment of the present invention; and

FIG. 5 is flow chart illustrating operations for regenerating infrared code signals captured by a universal control device in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As the number of existing electronic devices that are desired to be controlled by end users increases, then the number of separate remote control units needed to control the devices also increases. This can be frustrating and cumbersome for the end user. In order to reduce or even eliminate the multiple remotes that a user may collect, a universal control or a programmable controller can be used. It can be difficult to initially program such universal control devices, especially if the programming includes a significant amount of hand keying to find or program the varying codes.

One method of programming a universal control is to enable the universal control to record IR control codes directly from proprietary infrared controls or remote control devices as the IR control signals are sent. Another way the IR control codes for a universal control or similar devices can be obtained is from a database of control codes stored in a database accessible via the Internet.

There are many other ways that control codes can be captured or stored, and some of these methods will be enumerated later. However, there may be errors in the stored or captured control codes, as compared to the control codes manufacturer specifications for a specific machine or the control codes which actually work for a consumer electronic unit.

Errors in the stored control codes may be introduced when the control codes are initially entered or captured. The errors can also be introduced when the infrared re-transmission takes place or when data become randomly corrupted. Accordingly, correction of such control codes is valuable because otherwise the control code may not activate the target device due to the control code distortion or errors.

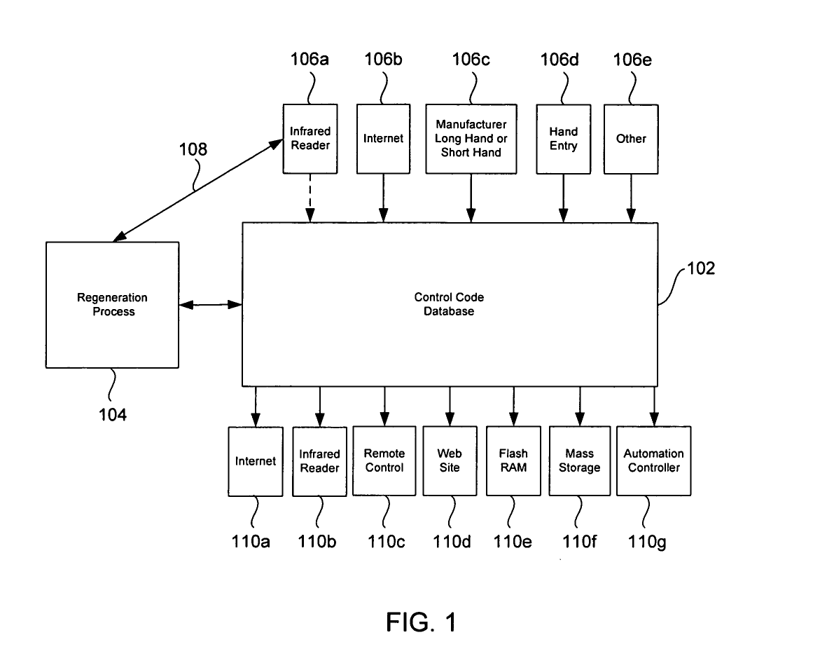

A system and method are provided in one embodiment for regenerating or enhancing infrared code signals. FIG. 1 illustrates a system for regenerating infrared code signals that are used to control an automated device. A control signal can be received from one or more input sources. The input sources 106a-e can be one of many device types. One input source is an infrared reader 106a that can detect and receive infrared signals directly from an IR type device (e.g., a remote control) that is generating the infrared code signals. The infrared reader can be a stand alone device or included in other electronic devices such as automation controllers, remote controls, laptops, handheld computing devices or other electronic devices. Codes obtained from the infrared reader can be stored in a control code database 102 with which the infrared reader is in electronic communication.

In other embodiments, the infrared code signals can be received from input sources such as internet databases and websites 106b, a manufacturer's database in longhand or shorthand format 106c, a hand-coded entry of the infrared code signals 106d, or any other data input and entry method 106e that can supply the infrared code signals regardless of whether they are captured using an infrared or electronic input device.

A regeneration process 104 can be configured to identify the format and code of the infrared control signals, as the control signals are directly received 108 from the input source. Then a corrected long hand copy of the infrared control signal can be regenerated by the regeneration process based on the identified format and code. The control code database 102 can store the regenerated and corrected long hand copy of the infrared control signals when the codes are received from the regeneration process.

In an alternative embodiment of the invention, the uncorrected long hand copies of the infrared control signals can be stored in the database first. Later, the regeneration process can regenerate and correct the control signals in the database. This may happen on a timed job basis or at the command of an administrator.

The regeneration process can identify the carrier frequency, encoding scheme, device type and control code values. In other words, the codes may be converted into a short hand format that includes the parameters just described. This allows the regeneration process to regenerate the control code from the short hand to a long hand format as timed pairs of IR bursts based on the identified control codes. Specifically, the control codes can be regenerated based on a manufacturer's specification or control codes that have been tested with the target electronic device. The values for these IR bursts can be stored in a table as described below.

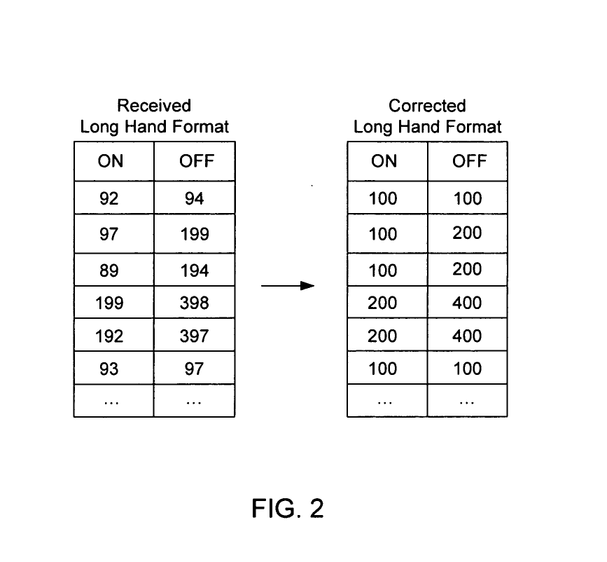

FIG. 2 illustrates an example of two tables which represent long hand formats of the infrared control codes. All infrared control codes include a specific carrier frequency that can be identified and stored with the table. One component of the infrared control transmissions include bursts of infrared at the carrier frequency that can be recorded as pairs of on and off bursts. In some control codes, a certain number of pairs may be a preamble that does not repeat, but a preamble is not required. Then the control codes may follow the preamble. The table values may be stored as time values or cycles of the carrier frequency. Accordingly, the table in the database may store the carrier frequency, a preamble flag to represent whether a preamble exists, and a number of transition pairs in the preamble (not shown).

The table on the left side of FIG. 2 illustrates an example of uncorrected long hand format control codes are uncorrected. The first infrared burst pair may be recorded an “on” burst that lasts 92 microseconds while the “off” time is 94 microseconds. In contrast, the actual infrared code for the electronic device may be defined by the manufacturer specifications as having an “on” burst that lasts 100 microseconds and an “off” period that lasts 100 microseconds.

When the uncorrected code is played back to control a specific electronic device, the control code may not work because of the errors that have been introduced. Thus, the correction process can regenerate and store the corrected codes in the long hand format as the codes were originally specified. Then even if errors are introduced by in the playback electronics, the infrared control codes sent to the target device are much closer to the original and the codes are likely to activate the desired device.

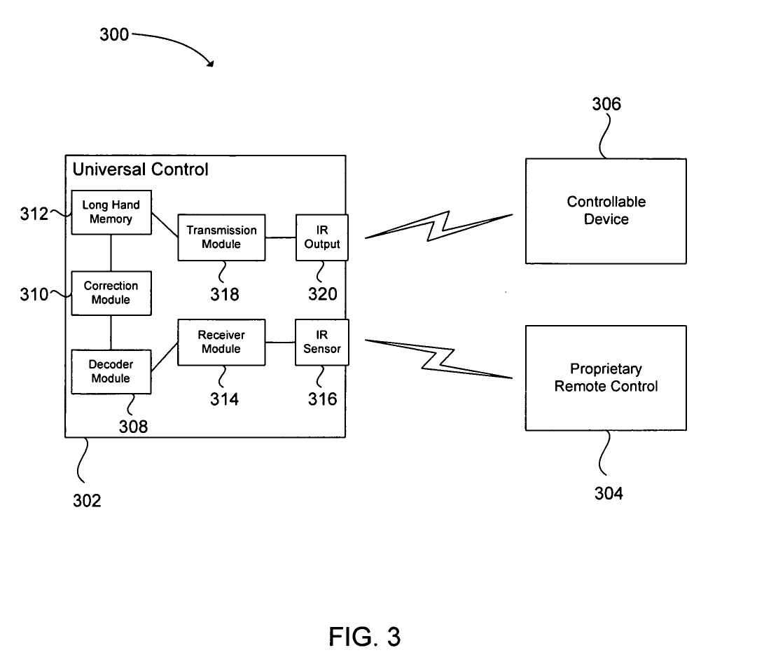

FIG. 3 illustrates a system for regenerating the infrared code signals. A universal controller device or universal control 102 is configured for receiving infrared control signals from a proprietary infrared control device 104. The proprietary infrared control device may be a proprietary IR remote control. For example, proprietary remote controls may be programmed to control televisions, DVD players, satellite television control boxes, cable television control boxes, stereos, audio amplifiers, personal computers, consumer electronics, or any other electronic devices that are controlled by infrared signals.

As described previously, one method of programming a universal control is to enable the universal control to read IR control codes directly from proprietary infrared controls or remote controls as the IR control signals are sent. This means that a proprietary IR control or remote control can be directed toward the IR sensor(s) of the universal control while the universal control is set to learn mode.

When the universal control begins to receive the IR codes, the universal control can identify the carrier frequency at which the control signals are being received. Then the timing patterns of IR bursts and the blank intervals can be recorded. In other words, the time length of each burst and interval may be recorded at the given carrier frequency. Unfortunately, errors can begin to enter into the recorded codes during recording. This means that the universal control may record the errors that exist in the transmission or receiving of the infrared control codes.

Another way the universal control can obtain control codes is by downloading them from a database of control codes. Even in this format, the database may have corrupted control codes that may need to be regenerated.

There are other points at which such errors may enter into the universal control's or remote control's playback system. One point of error introduction may be when the proprietary infrared remote control is sending the original control codes. For example, the original signal may be off by some percentage (e.g., 5%-25%) from the actual control signal that is desired to be transmitted. This amount of error may be created by low batteries, anomalies in the proprietary remote control's electronic circuitry, or LED infrared transmitter errors that are introduced during manufacturing.

While the target electronic device (e.g., DVD player, TV, etc.) might respond to control codes even with one layer of errors, a second layer of errors may then be introduced. Additional errors can be introduced when the infrared control codes are captured by the receiving universal control. For example, the captured infrared signals may be recorded too slowly due to circuit errors or infrared sensor errors. In addition, errors in the storage hardware can result in two or more layers of stored errors.

A third layer of errors may be produced when the infrared re-transmission takes place. There may be artifacts in the transmission hardware and LED units of the universal control which cause the signal to be transmitted to the home automation device or controllable electronic device at an even slower rate. In addition, other errors may be introduced in this operation. The net result is that although the learned infrared codes are transmitted to control the desired device, the control codes may not work because of the accumulated errors.

To reiterate, the accumulated errors described may be created by slower recording, storage problems, or transmission problems. In addition, other types of errors can enter into the system due to missing bits, light interference from fluorescent lights, electronic circuit errors, and other related problems.

A universal control device 302 is defined herein as an infrared control device that can receive and learn IR control signals and control many other devices using an infrared communications channel and IR output. The term universal as used here does not mean that the universal control device can actually control every electronic device on the market. However, the term universal is used in the context that the universal control device can control a large number of disparate devices from separate manufactures which use differing control code formats.

The universal control device 302 can include the hardware and software to receive IR signals from proprietary remote controls 304 and to then correct the codes by regeneration for retransmission in order to control electronics, home automation devices, and other electronic devices. An example of a universal control device is a media controller, home theater controller, or receiver component that can configure, route, and control audio-visual devices and home automation devices. The universal control device or media controller can include an IR sensor 316 and a receiver module 314 for receiving the infrared control signals and translating the signals into a useable electrical impulse format.

A decoder module 308 may be contained in the universal control device 302. The decoder module can be configured to identify the format of the infrared control signals from the proprietary infrared control device 304. Identifying the format includes determining the carrier frequency that the control codes are being sent at. After the frequency has been found, the decoder can also recognize the preamble that is contained in the infrared control signal. The device type can be extracted from the infrared control signal by capturing a transmitted device address. Then the repeated control code can be identified.

Once the decoder recognizes the carrier frequency, preamble, device type, and the control codes that are being sent over the infrared channel, then the control signals can be regenerated or corrected. A correction module 310 is included for regenerating a clean long hand copy of the infrared control signal based on the identified format, device and codes sent. This regeneration can be performed by identifying the manufacturer, carrier frequency, device type and control code that was sent in the original long hand format transmission. Identifying this information may produce a short hand code, such as: RC5 (Protocol), 49255 (Device), 59 (Code).

An identified short hand code can then be used to find the specification data use to regenerate the correction signal. The specification data is a representation of the code in digital format, short hand format or a compressed format. The specification data or short hand data can then be used to regenerate a long hand version of the signal that can be stored in a database, RAM, Flash RAM, a hard drive, or a similar long hand storage memory 312.

The encoded copy of the control codes are defined as the digital or short hand representations of the codes and the defined delivery frequency. The long hand versions are the long hand stored representation of the control codes that represent the time duration of each burst (or on cycle) and each space (or off cycle) at the given carrier frequency.

The corrected long hand copy of the infrared control signals can be used by the transmission module 318 and IR output LED 320 for transmitting the regenerated or corrected long hand copy of the infrared control signal to a home automation device or another controllable device 306. The transmission takes place using the IR output module, which generates the IR signals for the home automation device.

For example, a component mounted emitter can be used to channel the IR codes directly to the IR receiver window of another device. The component mounted emitter may be adhered or fastened onto the window of the electronic device or mounted inside a cabinet within a short distance of the IR receiver window.

In an alternative embodiment, a “blast” emitter can be used to address one or more electronic components. Such blast type of emitters may be placed within a few inches or feet of the electronic device. However blast emitters have the drawbacks of being blockable, inelegant, and blast emitters may lack zone control.

Examples of home automation electronic devices that an individual may desire to couple to the universal control or media controller include: television screens, computer monitors, video projection systems, CD players, DVD players, VCRs, audio equipment, surround sound stereo equipment, video cameras, microphones and other audio-visual and entertainment equipment. Other types of devices that can be routed into the media controller can include home automation equipment such as: lighting control switches, fireplace relays, dimmers, thermostats, HVAC, timers, alarm systems and other types of home automation equipment which can be connected into the media controller. While the term home automation is being used in this application, these electronic components that have been described can be used with the media controller in other settings including business, education, government, hotels, churches, broadcasting and entertainment facilities.

The universal control can have a housing containing switching circuitry and other electronics for appropriately controlling, processing, and routing electronic signals. The housing can have a port panel on one of the faces of the media controller. The port panel can be located on the back, side, top, front or even bottom of the media controller. However, the port panel is most likely to be located on the rear of the media controller. A plurality of communication ports can be located in the panel to control any of the many devices that have been described previously. Many of these ports can be electrical connection ports such as audio or video ports, relay ports, serial ports, parallel ports, USB ports, Ethernet ports or similar ports for receiving electrical connection cables. Another type of port can be an infrared receiver or transmission port.

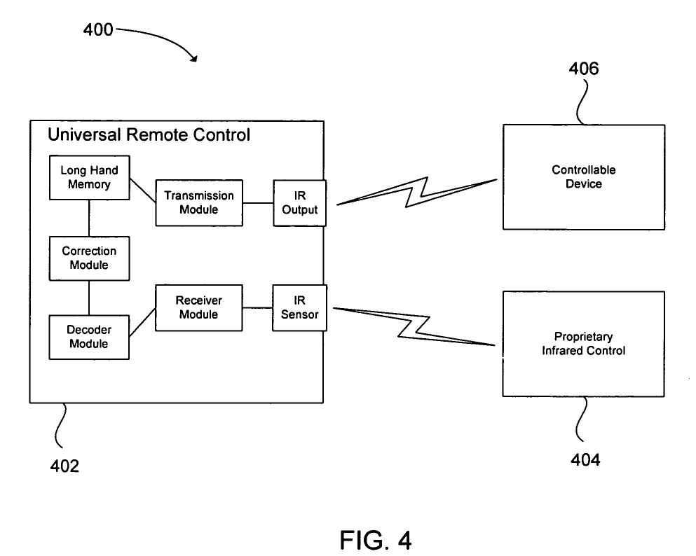

FIG. 4 illustrates an example of a universal remote control 402 that is a single convenient device for controlling audio/video devices and home automation. Such a device may be fully customizable to the user's needs. In addition, the universal remote control can contain the same components and use the same methods as the universal control but the remote control can be a portable size. In comparison, a universal control (e.g., media or home theater controller) may not be as portable and may be sized to be located on a shelf or a similar location.

The universal remote control can learn IR control codes from several proprietary remotes 404 and then regenerate or correct those codes so they are accurately sent to the electronic devices and home automation components 406 that are to be controlled. The regenerated codes can be stored in a memory or database, just as in the universal control embodiment.

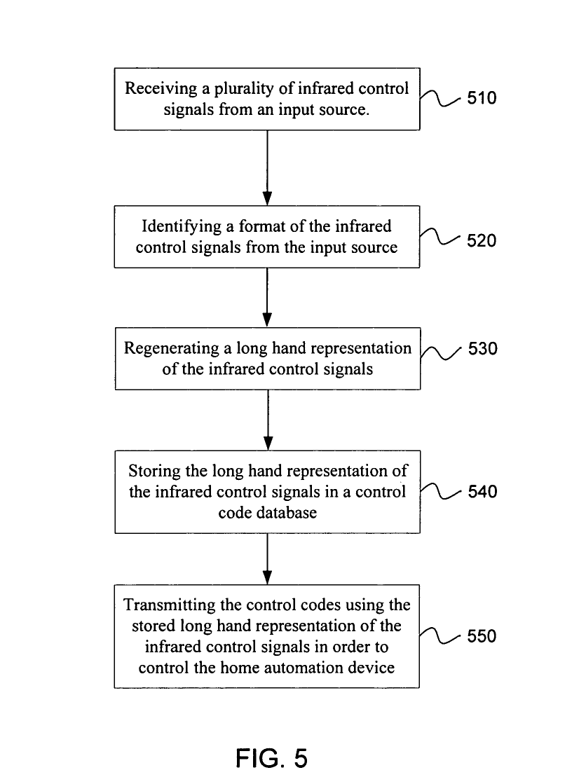

FIG. 5 is a flow chart illustrating a method for regenerating infrared code signals captured by a universal control device. The method includes the operation of receiving a plurality of infrared control signals from an input source, as in block 510. The plurality of control signals can be a single packet of control information or multiple packets of control information. For example, a packet of information may have a preamble, device address and a control code for the button being pushed.

The recorded signals may be received as an unknown infrared signal in a longhand format. The longhand format of the signal can be stored or buffered temporarily as it waits for decoding or recognition. For example, the IR control signals may be received from a proprietary remote control or another IR transmitting device.

A format of the infrared control signals from the proprietary infrared control device can then be identified or decoded, as in block 520. As discussed previously, determining the format of the infrared control signals includes identifying the carrier speed of the control signal which. Once the appropriate carrier frequency is found, then the device type can be identified using a transmitted device address, and the control code can be identified. A control code may include a preamble in the infrared control signal which can also be identified as the signal begins.

Another operation is regenerating or correcting the infrared control signals based on the identified format of the infrared control signals. The regeneration process can look up the digital or short hand format of the infrared control signals in order to regenerate the signals in a long hand format within the device. The long hand representation of the infrared control signals can then be regenerated, as in block 530.

The regenerated long hand representation of the infrared control signals may be stored in a database, as in block 540. The long hand representation of the infrared control signals can be stored in a Flash RAM, on a hard drive, or in another storage medium. The long hand format of the control code can be stored in a database that allows for quick retrieval of the regenerated long hand codes when a device needs to be controlled. For example, the database can be an indexed file, a table, a hash table, a relational database, or some other type of database for storing the IR control codes.

The resulting regenerated code can be more accurate, stable, and effective at controlling electronic devices and home automation devices. In addition, the regenerated code can be used later. These control codes can be transmitted to a home automation device or audio/video device using the stored long hand representation of the infrared control signals, as in block 550. This allows the home automation device or other electronic component to receive a clear and recognizable control code, which allows the device to carry out the desired functions.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for regenerating infrared code signals configured to control an automated device, comprising the steps of:
receiving a plurality of infrared control signals from an input source;
identifying a format of the infrared control signals from the input source;
regenerating a long hand representation of the infrared control signals based on the identified format of the infrared control signals; and
storing the long hand representation of the infrared control signals in a control code database.

2. A method as in claim 1, wherein the step of receiving a plurality of infrared control codes further comprises the step of receiving a plurality of infrared control codes from an infrared reader.

3. A method as in claim 1, wherein the step of identifying a format further comprises the step of identifying control codes contained in the infrared control signal.

4. A method as in claim 1, further comprising the step of storing the long hand representation of the infrared control signals using a mass storage device to store a database of long hand representations.

5. A method for regenerating infrared code signals configured to control an automated device, comprising the steps of:
accessing a plurality of infrared control signals in a control code database;
identifying a format of a selected control code from the infrared control signals in the database;
regenerating a long hand representation of the selected control code based on the identified format; and
storing the long hand representation of the regenerated control code in the control code database.

6. A method as in claim 5, further comprising the steps of transmitting the regenerated control codes from the database to a home automation device using the stored long hand representation of the infrared control signals in order to control the home automation device.

7. A method for regenerating infrared code signals, comprising the steps of:
recording a plurality of infrared control signals from a proprietary infrared control device, as received by a universal control device;
identifying a format of the infrared control signals from the proprietary infrared control device;
regenerating a long hand representation of the infrared control signals based on the identified format of the infrared control signals; and
storing the long hand representation of the infrared control signals in order to control electronic devices.

8. A method as in claim 7, further comprising the steps of transmitting the control codes from the universal control device to a home automation device using the stored long hand representation of the infrared control signals in order to control the home automation devices.

9. A method as in claim 7, wherein the step of identifying the format of the infrared control signals further comprises the step of identifying the device type and control code represented by the infrared control signal.

10. A method as in claim 7, wherein the step of identifying the format further comprises the step of identifying the device type associated with the infrared control signal using a transmitted device address.

11. A method as in claim 7, further comprising the step of recording the infrared control signals in a long hand representation when the infrared control signals are received by the universal control device.

12. A method as in claim 7, further comprising the step of storing the long hand format of the infrared control signals which includes a preamble and a repeated control code.

13. A method as in claim 7, wherein the step of recording a plurality of infrared control signals further comprises the step of storing the long hand format of the control code in a database in a memory of the universal control device.

14. A system for regenerating infrared code signals configured to control an automated device, comprising:
an input source to supply infrared control signals;
a cleaning process configured to identify a format of the infrared control signals from the input source and to regenerate a long hand copy of the infrared control signal based on the identified format; and
a database configured to store the regenerated long hand copy of the infrared control signals received from the cleaning process.

15. A system as in claim 14, wherein the input source can be an infrared control code capture device.

16. A system for regenerating infrared code signals recorded by a universal control device, comprising:
a receiver module in the universal control device, the receiver module being configured to receive infrared control signals from a proprietary infrared control device;
a decoder module contained in the universal control device, configured for identifying a format of the infrared control signals from the proprietary infrared control device;
a correction module, in communication with the decoder module, configured to generate a corrected long hand copy of the infrared control signal based on the identified format; and
a memory module configured to store the corrected long hand copy of the infrared control signals received from the correction module.

17. A system as in claim 16, further comprising a transmission module configured to transmit the corrected long hand copy of the infrared control signal to a home automation device.

18. A system as in claim 16, wherein the universal control device further comprises a receiver module and IR sensor configured to receive the infrared control signals.

19. A system as in claim 16, wherein the decoder module is configured to identify the device formats associated with the infrared control signal in order to look-up a short hand version of the infrared control signals used to regenerate the long hand version of the infrared control signals.

20. A system as in claim 16, wherein the decoder module identifies the device type and a control code represented by the infrared control signal using a transmitted device address.

21. A system as in claim 16, wherein the decoder module recognizes a preamble that is contained in the infrared control signal.
